(19) United States
(12) Patent Application Publication
(10) Pub. No.: US 2024/0071194 A1
(43) Pub. Date: Feb. 29, 2024

(54) EMERGENCY ROOM INDICATION SYSTEM AND METHOD

(71) Applicant: John J Kramer, Amold, MO (US)

(72) Inventor: John J Kramer, Amold, MO (US)

(21) Appl. No.: 18/234,109

(22) Filed: Aug. 15, 2023

Related U.S. Application Data
(60) Provisional application No. 63/400,478, filed on Aug. 24, 2022.

(51) Int. Cl. G08B 17/10; G08B 5/36

(52) U.S. Cl. CPC G08B 17/10; G08B 5/36

(57) ABSTRACT

Emergency room indication systems and methods are provided that, when activated provide a visual indication to first responders to identify rooms in a building where vulnerable victims are located. Emergency room indication systems include a transmitter module and a receiver module. The receiver module is configured to be placed in a window. The transmitter module receives an alarm signal from a smoke detector and sends an activation signal to the receiver module. When the receive module receives the activation signal, it activates an indicator light that may be seen by first responders outside the building.

### FIELD OF THE INVENTION

Systems and methods of the present technology relate to room indication systems and methods that activate during emergency situations, and in particular to systems and methods to alert first responders of rooms within a building where vulnerable victims are located.

### DESCRIPTION OF RELATED ART

When there is an active emergency situation within a building, such as a fire, it is helpful for first responders to be able to identify and locate areas within the building where vulnerable victims may be located. For example, in the past, decals known as “tot-finder” decals were placed in windows in residential buildings to indicate rooms with children in them. However, such decals have many drawbacks and are not always effective. It would be desirable to provide an improved system for indicating to first responders where vulnerable victims are located within a building during an emergency situation.

### SUMMARY OF THE INVENTION

The present technology provides room indication systems and methods that can be used to alert first responders to the locations of rooms in which vulnerable victims, such as children or others who need special assistance, are located during emergency situations.

In at least one example, an emergency room indication system is provided for use with a wired fire detection system that includes at least one smoke detector. The emergency room indication system includes a transmitter module and a receiver module. The transmitter module includes a transmitter module housing and a transmitter. The receiver module includes a receiver module housing, a receiver, and at least one indicator light. The transmitter receives an alarm signal from a smoke detector, and sends an activation signal to a receiver module. The receiver module receives the activation signal and activates the at least one indicator light.

In another aspect, an emergency room indication system is provided that is incorporated into a smoke detector. The system includes a smoke detector that has a smoke detector housing. A sensor module is provided within the smoke detector housing that senses smoke and emits an alarm signal. A transmitter module is also provided within the smoke detector housing that is configured to receive the alarm signal. The transmitter module includes a transmitter that transmits an activation signal. The system also includes a receiver module that has a receiver module housing, a receiver, and at least one indicator light. The receiver module receives the activation signal and activates the at least one indicator light.

In yet another aspect, an emergency room indication method is provided that includes: receiving by a transmitter module an alarm signal generated by a smoke detector; transmitting from the transmitter module an activation signal; receiving the activation signal by a receiver module; and activating at least one indicator light by the receiver module.

### BRIEF DESCRIPTION OF THE DRAWINGS

Specific examples have been chosen for purposes of illustration and description, and are shown in the accompanying drawings, forming a part of the specification.

FIG. 1 illustrates one example of an emergency room indication system of the present technology.

FIG. 2 illustrates an alternative example of an emergency room indication system of the present technology.

FIG. 3 illustrates the receiver module of FIG. 1 mounted to a window.

FIG. 4 illustrates a receiver module of the present technology that includes optional features.

FIG. 5 illustrates a flow chart of one example of an emergency room indication method of the present technology.

While various embodiments discussed herein are amenable to modifications and alternative forms, aspects thereof have been shown by way of example in the drawings and are described in detail herein. It should be understood, however, that the disclosure is not limited to the particular embodiments described, and instead is meant to include all modifications, equivalents, and alternatives falling within the scope of the disclosure. In addition, the terms “example” and “embodiment” as used throughout this application is only by way of illustration, and not limitation, the Figures are not necessarily drawn to scale, and the use of the same reference symbols in different drawings indicates similar or identical items unless otherwise noted.

### DETAILED DESCRIPTION

Emergency room indication systems and methods of the present technology generally include a transmitter module and a receiver module. The transmitter module receives an alarm signal from an emergency detection device, such as a smoke detector, and transmits an activation signal to the receiver module. The receiver module receives the activation signal and activates at least one indicator light.

The systems and methods of the present technology may be used to provide a visual indication to first responders of the rooms within a building where victims are located, and may be particularly useful when used to indicate the rooms within a building where vulnerable victim are located. For example, the receiver module may be configured to be mounted to a window or window sill in an exterior window of a room in a building, such as a residence, where a vulnerable victim is located. Vulnerable victims may be anyone who may need assistance during an emergency, such as a child, elderly person, or disabled person. The receiver module is configured such that the at least one indicator light, when activated, may be visible to first responders. In at least some examples, the receiver module is configured such that the at least one indicator light may be directed outwardly such that it may be seen by first responders outside the building. Systems and methods of the present technology may assist first responders in landmarking a building in the event of a fire, and may assist first responders in prioritizing their actions in an effort to save lives.

In at least some examples, emergency room indication systems and methods are configured to be used in the event of a fire. In such examples, the transmitter module may be connected in line with a smoke detector in a wired smoke detection system of a building, or may be included as a component in a smoke detector as a stand alone device.

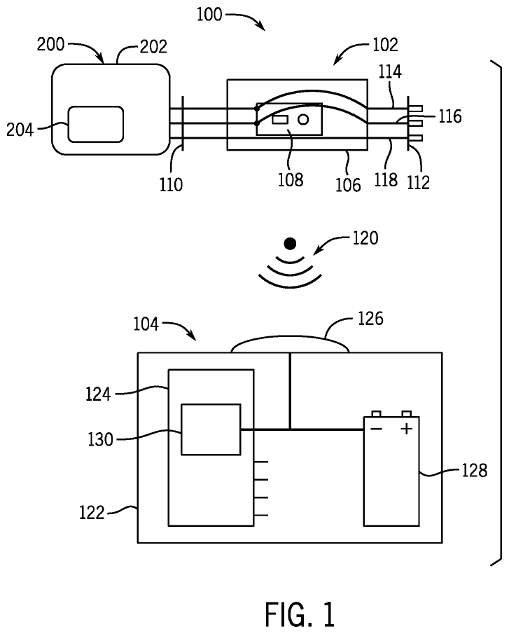

FIG. 1 illustrates one example of an emergency room indication system 100 of the present technology. The emergency room indication system 100 includes a transmitter module 102 and a receiver module 104. In this example, the transmitter module 102 is configured to be installed in line with a smoke detector 200 in a wired smoke detection system. As shown, the transmitter module 102 has a transmitter module housing 106 and a transmitter 108, and is installed connected to, but external to the smoke detector 200. The smoke detector 200 includes a smoke detector housing 202, and a sensor module 204 within the smoke detector housing 202 that senses smoke and emits an alarm signal.

As shown in FIG. 1, the transmitter module 102 includes a male adapter 110, which is configured to connect to the wired smoke detector, and a female adapter 112, which is configured to connect to the wired smoke detection system. Wires, such as a neutral wire 114, signal wire 116, and a hot wire 118, may be operatively connected at a first end to the male adapter 110 and at a second and to the female adapter 112. The wires run through the transmitter module 102, and have an intermediate connection to the transmitter 108 such that the transmitter 108 received any alarm signal generated by the smoke detector. The transmitter module 102 may receive power from the wires.

In examples such as the illustrated example, the transmitter module 102 is configured to be installed in line with a smoke detector in a wired smoke detector system. Installation of the transmitter module 102 may begin with removing the wired smoke detector from the bracket on which it is installed, and unplugging the wire harness that connects the smoke detector to the rest of the wired system. The next steps of installing the transmitter module 102 may include plugging the wire harness in to one end of the transmitter module 102, and plugging the other end of the transmitter module 102 into the smoke detector. The smoke detector may then be re-installed on its bracket.

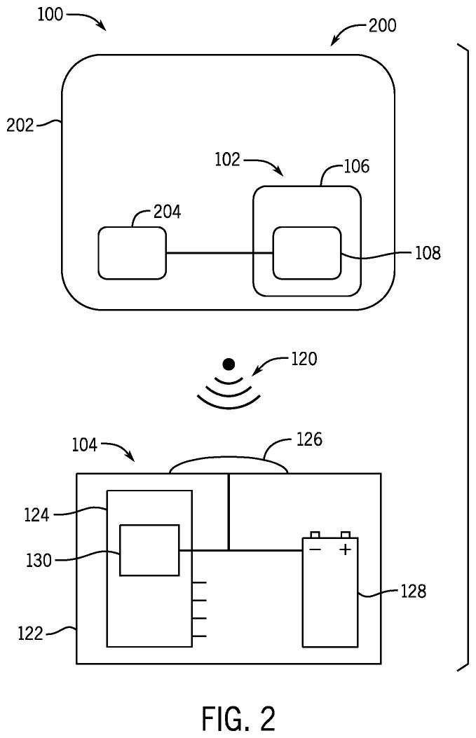

FIG. 2 illustrates an alternative example of an emergency room indication system 100 of the present technology, which is incorporated into and includes the smoke detector 200. The emergency room indication system 100 includes a transmitter module 102 and a receiver module 104. In this example, the transmitter module 102 is configured to be, and is, installed within the housing 202 of the smoke detector 200. As shown, the transmitter module 102 may have a transmitter module housing 106, and has a transmitter 108. In yet another alternative, the transmitter module 102 may attached to the smoke detector 200 on the outside of the smoke detector housing 202.

Referring to the examples in both FIGS. 1 and 2, A sensor 204 in the smoke detector 200 senses smoke and generates an alarm signal, and the transmitter 106 receives the alarm signal. When the transmitter 108 receives an alarm signal from the sensor 204 of the smoke detector 200, the transmitter 108 sends an activation signal 120 to the receiver module 104. The transmitter 108 may be a wireless transmitter, such as a radio frequency (RF) transmitter or Bluetooth transmitter. In at least one example, the transmitter 108 may be an RF 433 mHz transmitter. When the transmitter 108 is a wireless transmitter, the transmitter 108 sends the activation signal wirelessly to the receiver module 104.

The receiver module 104 includes a receiver module housing 122, a receiver 124 and at least one indicator light 126. When the receiver 124 receives the activation signal 120, the receiver 14 activates the at least one indicator light 126. In the illustrated example, the receiver module 104 includes a latching electrical relay 130 that activates the at least one indicator light 126 and keeps it on during the emergency situation. The receiver module housing 122 may be made of any suitable material, such as a plastic, preferably a plastic that is similar to the plastic used for the housing in standard smoke detectors. The receiver module 104 may be powered in any suitable manner, and in at least come examples is configured to house and operatively connect at least one battery 128 that can provide power to the components of the receiver module 104. The at least one battery 128 in the illustrated example is a 9 v battery.

The receiver module housing 122 may be configured such that the battery 128 is accessible and can be replaced by a user. Instructions may be provided with the system instructing the user to replace the battery 128 annually, such as at the same time as when changing detector batteries. Additionally, a sticker (not shown) may be provided that is configured for a user to attach the sticker to the smoke detector, and the sticker may contain printing that reminds the user to replace the battery 128 annually.

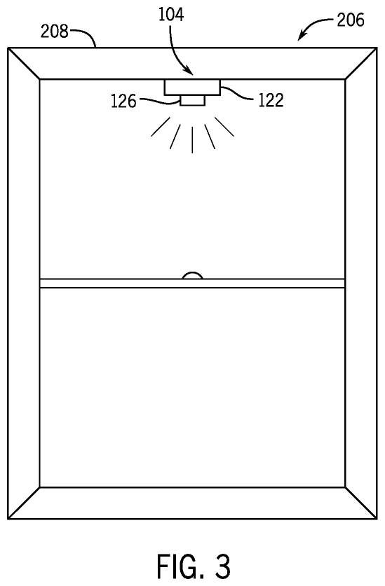

FIG. 3 shows one example of a receiver module 104 mounted to the upper window sill 208 in a window 206. The receiver module housing 122 may have any suitable shape, and in the illustrated example is rectangular. The receiver module housing 122 may have any suitable color, and in the illustrated example is white, which may be preferred because many residential window sills are white and the device may thus match the window sill and be less conspicuous when the system 100 is installed but not activated. Preferably, the receiver module 104 is configured to be small and unobtrusive, and may be provided with multiple mounting options to accommodate most residential window styles. The receiver module 104 may preferably be configured to be unnoticeable from the exterior of the window on which it is mounted until it is activated.

As shown in FIG. 3, the at least one indicator light 126 is illuminated. The at least one indicator light 126 may include one or more light sources, which may each be a light emitting diode (LED). The at least one indicator light 126 may be anu suitable color, and in at least one example is green. Green may be a preferred color for the indicator light because it may be least likely to be confused with the reflection of emergency vehicle lights, in which blue and red are primarily used.

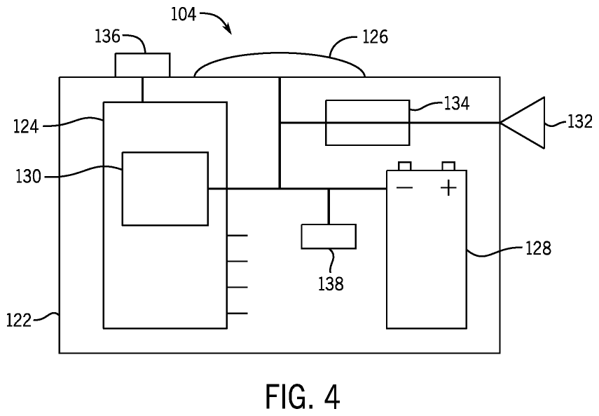

There are several optional features that may also be included in emergency room indication systems 100 of the present technology. For example, referring to FIG. 4, the receiver module 104 may include at least one speaker 132 that emits an audible alarm when the receiver 124 receives the activation signal 120. In at least one example, the receiver module 104 may include at least one non-volatile memory 134 that stores a pre-recorded message, such as a message that advises the vulnerable victim of actions to take during an emergency situation, and the pre-recorded message may be transmitted through the speaker as or in addition to the audible alarm. As another example, the receiver module 104 may include a reset button 136, or a timer 138 based on the signal from the activated detector, in order turn off and reset the receiver module 104 in the event of a false alarm or for subsequent uses after an initial emergency event.

In at least some examples of emergency room indication systems 100 of the present technology, it may be preferable to install the transmitter module 102 and the receiver module 104 within a certain proximity to each other. For example, the transmitter module 102 may be installed on or in a smoke detector 200 outside the room of the vulnerable victim, on a wall or on the ceiling within a desired proximity, such as within about 6 feet of the door of the room of the vulnerable victim.

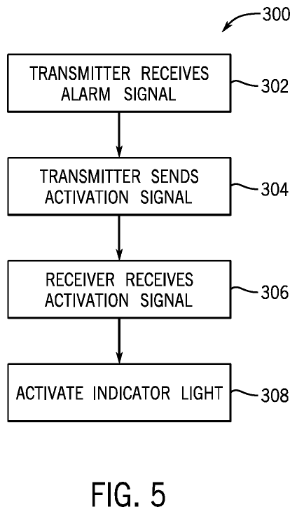

FIG. 5 is a flow chart illustrating one example of a method of operation 300 of an emergency room indication system 100 of the present technology. The method 300 begins at step 302, which is receiving by a transmitter module of an alarm signal generated by a smoke detector. The method 300 then proceeds form step 302 to step 304, which is transmitting from the transmitter module an activation signal. Once the transmitter sends the activation signal to the receiver, the method may proceed to step 306, which is receiving the activation signal by a receiver module. When the receiver module receives the activation signal, the method may proceed to step 308, which is activating at least one indicator light by the receiver module.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. An emergency room indication system for use with a wired fire detection system that includes at least one smoke detector, the emergency room indication system comprising:
a transmitter module including a transmitter module housing and a transmitter;
a receiver module including a receiver module housing, a receiver and at least one indicator light;
wherein the transmitter receives an alarm signal from a smoke detector, and sends an activation signal to a receiver module, and the receiver module receives the activation signal and activates the at least one indicator light.

2. The emergency room indication system of claim 1, wherein the receiver module further includes a power source within the receiver module housing that provides power to the receiver and the at least one indicator light.

3. The emergency room indication system of claim 1, wherein the transmitter module is connected in line to wires of a wired smoke detector in a wired smoke detection system.

4. The emergency room indication system of claim 1, wherein the receiver module is remote from the transmitter module, and the transmitter module sends the activation signal wirelessly to the receiver module.

5. The emergency room indication system of claim 4, wherein the activation signal is a radio frequency signal.

6. The emergency room indication system of claim 1, wherein the at least one indicator light is a light emitting diode.

7. The emergency room indication system of claim 1, wherein the at least one indicator light has a color that is green.

8. The emergency room indication system of claim 1, wherein the receiver module is configured to be mounted to the frame of a window.

9. An emergency room indication system comprising:
a smoke detector including a smoke detector housing, a sensor module within the smoke detector housing that senses smoke and emits an alarm signal, and a transmitter module within the smoke detector housing that is configured to receive the alarm signal, wherein the transmitter module includes a transmitter that transmits an activation signal;
a receiver module including a receiver module housing, a receiver and at least one indicator light;
wherein the receiver module receives the activation signal and activates the at least one indicator light.

10. The emergency room indication system of claim 9, wherein the receiver module further includes a power source within the receiver module housing that provides power to the receiver and the at least one indicator light.

11. The emergency room indication system of claim 9, wherein the receiver module is remote from the transmitter module, and the transmitter module sends the activation signal wirelessly to the receiver module.

12. The emergency room indication system of claim 11, wherein the activation signal is a radio frequency signal.

13. The emergency room indication system of claim 9, wherein the at least one indicator light is a light emitting diode.

14. The emergency room indication system of claim 9, wherein the at least one indicator light has a color that is green.

15. An emergency room indication method comprising:
receiving by a transmitter module an alarm signal generated by a smoke detector;
transmitting from the transmitter module an activation signal;
receiving the activation signal by a receiver module; and
activating at least one indicator light by the receiver module.
